(19) United States
(12) Patent Application Publication
(10) Pub. No.: US 2010/0161105 A1
(43) Pub. Date: Jun. 24, 2010

(54) COMBINED PROCESS FOR BUILDING THREE-DIMENSIONAL MODELS

(75) Inventor: Paul Blake, Eden Prairie, MN (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: STRATASYS, INC., Eden Prairie, MN (US)

(21) Appl. No.: 12/642,127

(22) Filed: Dec. 18, 2009

Related U.S. Application Data
(60) Provisional application No. 61/139,800, filed on Dec. 22, 2008.

(51) Int. Cl. G06F 17/00

(52) U.S. Cl. 700/119

(57) ABSTRACT

A method and system for building a three-dimensional model, which include performing a subtractive removal process on at least one material feedstock to form a plurality of base seeds, performing an additive deposition process to deposit at least one material on at least a portion of a base seed target surface, and performing an assembly process to combine the plurality of base seeds to form at least a portion of the three-dimensional model.

### CROSS-REFERENCE TO RELATED APPLICATION(S)

This application claims priority to U.S. Provisional Patent Application No. 61/139,800, filed on Dec. 22, 2008, and entitled “Combined Process For Building Three-Dimensional Models”, the disclosure of which is incorporated by reference in its entirety.

### BACKGROUND

The present invention relates to a method and system for building three-dimensional (3D) models. In particular, the present invention relates to a method and system for building 3D models using combinations of subtractive processes and additive processes.

Digital manufacturing systems are used to build 3D models from digital representations of the 3D models (e.g., STL format files) using one or more layer-based additive techniques. Examples of commercially available layer-based additive techniques include fused deposition modeling, ink jetting, selective laser sintering, electron-beam melting, and stereolithographic processes. For each of these techniques, the digital representation of the 3D model is initially sliced into multiple horizontal layers. For each sliced layer, a build path is then generated, which provides instructions for the particular digital manufacturing system to form the given layer. For deposition-based systems (e.g., fused deposition modeling and jetting), the build path defines the pattern for depositing roads of modeling material from a moveable deposition head to form the given layer.

For example, in a fused deposition modeling system, modeling material is extruded from a moveable extrusion head, and is deposited as a sequence of roads on a platform in a horizontal x-y plane based on the build path. The extruded modeling material fuses to previously deposited modeling material, and solidifies upon a drop in temperature. The position of the extrusion head relative to the platform is then incremented along a vertical z-axis, and the process is then repeated to form a 3D model resembling the digital representation.

While layer-based additive techniques provide durable 3D models with high resolution, these processes may require significant production times to form the layers of the 3D models. This is particularly true for 3D models that require large raster-filled volumes. Furthermore, deposition times and complexities may be increased with the use of underlying support structures. Such support structures increase the amount of deposited material that is required, thereby further increasing deposition times and material costs. Thus, there is an ongoing need for processes to build 3D models having high resolutions, and which also reduce production times and material costs.

### SUMMARY

An aspect of the disclosure is directed to a method for building a three-dimensional model. The method includes performing a subtractive removal process on at least one material feedstock to form a plurality of base seeds, where each of the plurality of base seeds includes a mating surface, and at least one of the base seeds comprises a target surface. The method further includes performing an additive deposition process on at least a portion of the target surface to provide a coated target surface, and performing an assembly process to combine the plurality of base seeds to form at least a portion of the three-dimensional model, where the coated target surface constitutes at least a portion of an exterior surface of the three-dimensional model.

Another aspect of the disclosure is directed to a method for building a three-dimensional model, which includes selectively removing at least a portion of at least one material feedstock to form a plurality of base seeds, where at least a portion of the plurality of base seeds each comprise a target surface. The method also includes depositing a material onto the target surfaces to form at least one surface feature selected from the group consisting of topographical features, color patterns, coatings, and combinations thereof, and separating the plurality of base seeds from the at least one material feedstock. The method further includes assembling the plurality of base seeds to form at least a portion of the three-dimensional model, where the at least one surface feature constitutes at least a portion of an exterior surface of the three-dimensional model.

A further aspect of the disclosure is directed to a system for building a three-dimensional model. The system includes at least one subtractive removal station configured to form a plurality of base seeds from at least one material feedstock, where each of the plurality of base seeds comprises a mating surface, and at least one of the seeds comprises a target surface. The system also includes at least one additive deposition station configured to deposit at least one material on at least a portion of the target surface to provide a coated target surface, and at least one assembly station configured to combine the plurality of base seeds to form at least a portion of the three-dimensional model, wherein the coated target surface constitutes at least a portion of an exterior surface of the three-dimensional model.

### BRIEF DESCRIPTION OF THE DRAWINGS

FIG. 1 is a front view of a first exemplary 3D model built pursuant to a method of the present disclosure.

FIG. 2 is a top perspective view of base seeds of the first exemplary 3D model fabricated from a material feedstock.

FIG. 3 is a sectional view of a portion of a base seed, which illustrates a coating deposited on a target surface of the base seed.

FIG. 4 is a bottom perspective view of the base seeds after separation from the material feedstock.

FIG. 5 is a front view of a pair of subparts being assembled to form a portion of the first exemplary 3D model.

FIG. 6 is a flow diagram of a suitable embodiment of the method of the present disclosure.

FIG. 7 is a side view of a second exemplary 3D model built pursuant to a method of the present disclosure.

FIG. 8 is a side view of base seeds of the alternative second exemplary 3D model fabricated from a material feedstock.

FIG. 9 is a side view of the base seeds after an additive deposition process is performed.

FIGS. 10A-10D are perspective schematic illustrations of an automated system for performing the method of the present disclosure.

### DETAILED DESCRIPTION

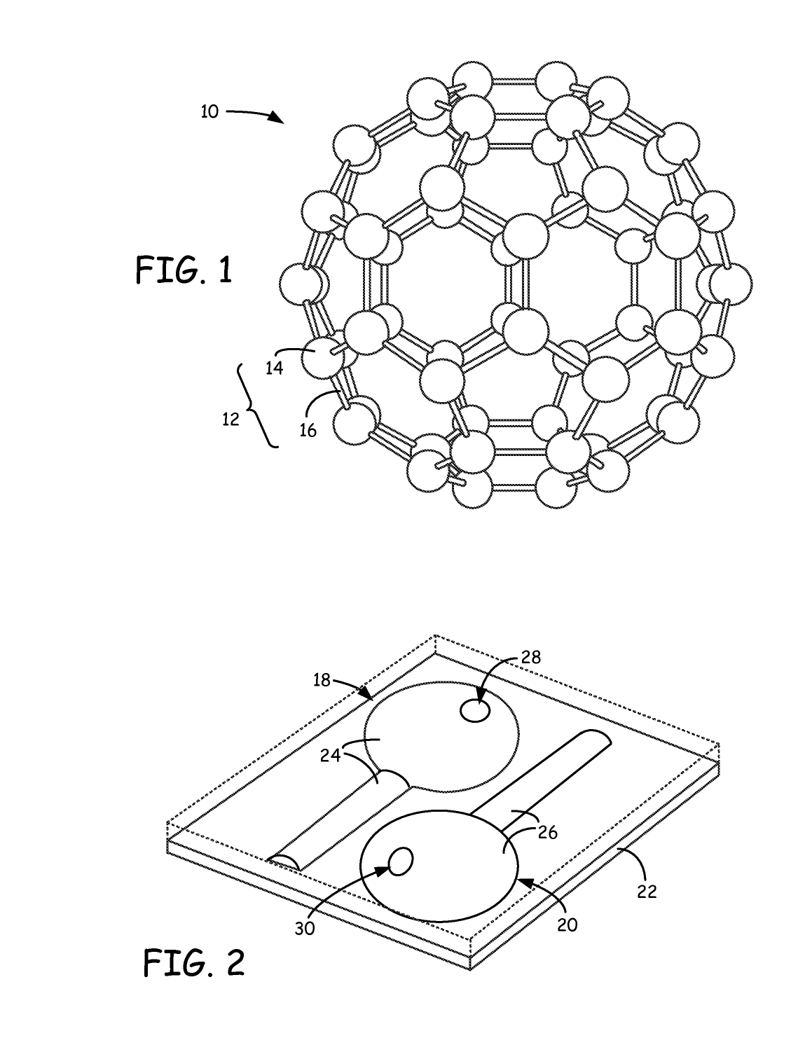

FIGS. 1-5 illustrate 3D model 10 being built from a digital representation pursuant to the method of the present disclosure. As discussed below, the method involves a combination of a subtractive removal process, an additive deposition process, and an assembly process, and is suitable for building 3D models having a variety of geometries with reduced production times and reduced material costs. As shown in FIG. 1, 3D model 10 is a C₆₀ fullerene molecular model that exhibits a complex geometry having extensive interstitial regions. This buckyball arrangement is derived from a plurality of subparts 12, where each subpart 12 includes ball portion 14 (representing a carbon atom) interconnected with link portion 16 (representing a chemical bond).

FIG. 2 is a top perspective view of base seeds 18 and 20 fabricated from material feedstock 22, where base seeds 18 and 20 are suitable building blocks for fabricating each subpart 12 of 3D model 10 (shown in FIG. 1). The method of the present disclosure may initially involve performing a subtractive removal process to form a plurality of base seeds from one or more material feedstock. As used herein, the term “subtractive removal process” refers to a process that selectively removes material from a material feedstock to attain a predetermined geometry. Examples of suitable subtractive processes include computer numerical control (CNC) processes, which may be used to selectively remove portions of a material feedstock to attain the desired geometries for each of the base seeds. Accordingly, the subtractive removal process may form base seeds 18 and 20 by selectively removing portions of material feedstock 22 to attain the geometries of base seeds 18 and 20.

The material feedstock (e.g., material feedstock 22) may be derived from a variety of different materials, such as polymeric, ceramic, wood, and metallic materials. Examples of suitable polymeric materials include thermoplastic materials, at least partially cross-linked materials, and combinations thereof. Examples of particularly suitable polymeric materials include foamed polymeric materials, such as extruded and/or thermofusible expanded foams of polystyrene, polypropylene, polyethylene, and combinations thereof. These particularly suitable materials are low cost materials that may be readily machined, exhibit good finishes, have a wide range of stiffness, have good fracture resistance, and have low densities. The material feedstock may also be provided in a variety of different media depending on the geometry of the desired base seeds. Examples of suitable media for the material feedstock include sheet and block geometry feedstock, which are easy to handle an inexpensive to produce. In the current example, material feedstock 22 exhibits a block geometry having original dimensions illustrated with broken lines.

The resulting geometries of base seeds 18 and 20 respectively include target surfaces 24 and 26, and apertures 28 and 30. Target surfaces 24 and 26 are upward and/or lateral facing surfaces of base seeds 18 and 20, respectively, and are the surfaces that receive deposited materials during the subsequent additive deposition process. Apertures 28 and 30 are openings disposed respectively through target surfaces 24 and 26 for receiving link portions 16 of additional subparts 12, as discussed below.

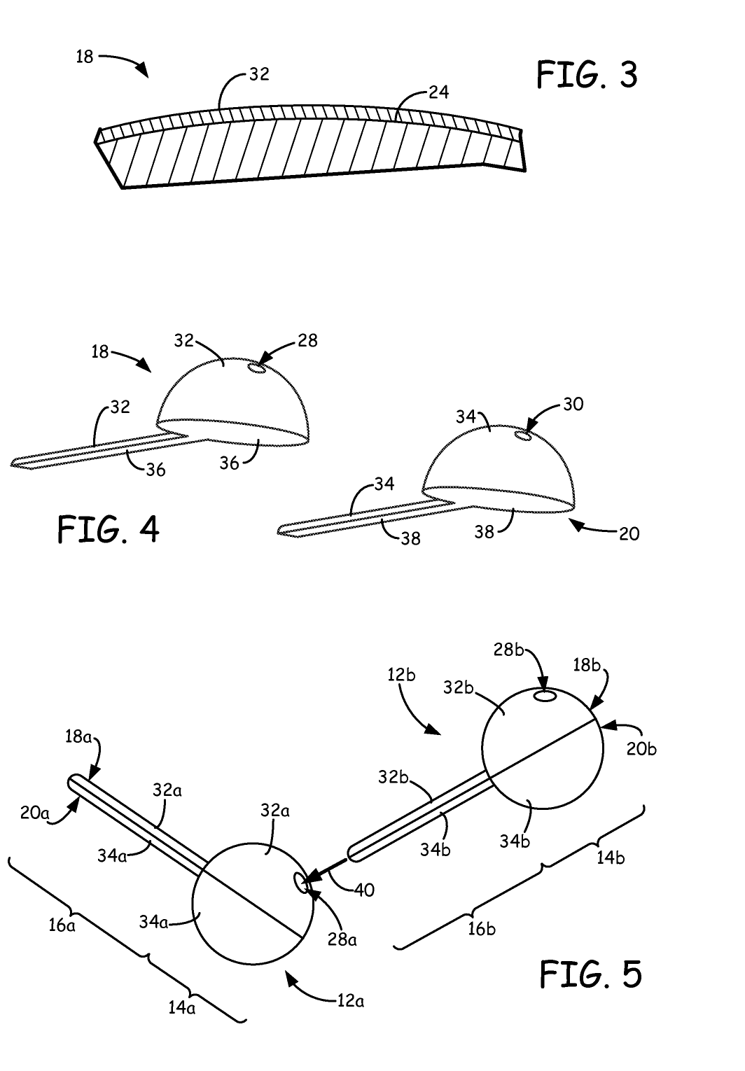

FIG. 3 is a sectional view of a portion of base seed 18, which illustrates coating 32 formed on target surface 24. After base seeds 18 and 20 are formed with target surfaces 24 and 26, the additive deposition process may then be performed to form topographical features, color patterns, and/or other types of coatings on one or both of target surfaces 24 and 26 (e.g., coating 32). As used herein, the term “additive deposition process” refers to a process that deposits one or more materials on a target surface to build up one or more topographical features on the target surface, to create one or more color patterns on the target surface, and/or to build one or more coatings on the target surface. Examples of suitable additive deposition processes for forming topographical feature(s), color pattern(s), and coating(s) on target surfaces of base seeds (e.g., target surfaces 24 and 26) include deposition-based digital manufacturing techniques, such as fused deposition modeling techniques and jetting techniques.

Suitable materials for use with an additive deposition process based on a fused deposition modeling technique include wax-based materials, thermoplastic materials, and combinations thereof. Examples of suitable thermoplastic materials include polyolefins (e.g., polyethylenes and polypropylenes), polystyrenes, polyetherimides, acrylonitrile-butadiene-styrene (ABS) copolymers, polycarbonates, polyphenylsulfones, modified variations thereof (e.g., ABS-M30 copolymers), polyoxazolines, ionomers (e.g., carboxylic acid/acrylate copolymers), and blends thereof. Suitable materials for use with an additive deposition process based on a jetting technique include any jettable material, such as photopolymerizable jetting materials and colorant inks. The above-discussed materials may also include additional additives, such as plasticizers, rheology modifiers, inert fillers, colorants, stabilizers, and combinations thereof.

The use of the additive deposition process allows high-resolution, colored features and coatings to be applied to target surfaces 24 and 26, which are otherwise not attainable with a subtractive removal process (e.g., a CNC process). For example, a CNC process alone is not capable of forming high-resolution topographical features or coatings on the interior-facing surfaces of 3D model 10, and is not capable of forming color patterns on the surfaces of 3D model 10. Furthermore, a deposition-based digital manufacturing process alone requires a substantial amount of support material to support overhanging regions of 3D model 10. This increases the production time and material costs required to build 3D model 10.

In comparison, a combination of the subtractive removal process and the additive deposition process allows high-resolution topographical features and coatings to be built in a layer-by-layer manner on one or more portions of target surface 24 and/or target surface 26. The given features/coatings may also be fabricated with a variety of color patterns, thereby allowing a wide variety of individualized features to be formed on each target surface. For example, coating 30 may exhibit one or more color patterns for aesthetic designs. The formed topographical features, color patterns, and coatings may extend over the entireties of one or more of the target surfaces, or only over a portion of one or more of the target surfaces, which may be based on the particular designs of the 3D models.

The resolutions of the topographical features and coatings built on target surfaces 24 and 26 (e.g., coating 32) may vary depending on the desired dimensions to be formed. Because the additive deposition process is used to deposit materials onto already formed seeds (e.g., base seeds 18 and 20), the resulting topographical features and coatings of the deposited materials may be small and directed to high-resolution details. This correspondingly reduces the production time required to deposit the materials. Examples of suitable resolutions in directions orthogonal to the target surface and in directions tangent to the target surfaces range from about 15 micrometers to about 5 millimeters, with particularly suitable resolutions ranging from about 50 micrometers to about 1 millimeter. However, as discussed above, the desired dimensions of the topographical features and coatings will generally dictate the resolution required.

FIG. 4 shows base seeds 18 and 20 after coatings 32 and 34 are respectively formed on target surfaces 24 and 26, and after base seeds 18 and 20 are removed from the remaining portion of material feedstock 22 (shown in FIG. 2). After the above-discussed subtractive removal process is complete, base seeds 18 and 20 typically remain integrally attached to the remaining portion of material feedstock 22. As such, base seeds 18 and 20 may be cut from the residual portion of the material feedstock, such as with a hot-wire foam knife, as discussed below. This provides mating surfaces 36 and 38, which are the portions of base seeds 18 and 20 that may be secured together to fabricate subpart 12 (shown in FIG. 1). This separation process may be performed before or after performing the additive deposition process. In one embodiment, the separation process is performed after the additive deposition process, which is beneficial for restricting movement of base seeds 18 and 20 during the additive deposition process.

After base seeds 18 and 20 are formed and coated, an assembly process may then be performed on the coated base seeds 18 and 20 to build 3D model 10 (shown in FIG. 1). As discussed below, the assembly process may be performed manually or in an automated manner, and may initially involve securing base seeds 18 and 20 together to form subpart 12 of 3D model 10. In the current example, base seeds 18 and 20 may be secured together at mating surfaces 36 and 38 to form subpart 12, and mating surfaces 36 and 38 are desirably secured together via chemical adhesion and/or mechanical interlocking. For example, one or both of mating surfaces 36 and 38 may be sprayed or otherwise coated with a pressure sensitive adhesive composition prior to assembly.

FIG. 5 illustrates a pair of subparts (referred to as subparts 12a and 12b) after base seeds 18a/20a and 18b/20b are secured together. As shown, this mating arrangement positions the high-resolution coatings 32a/34a and 32b/34b as the exterior surfaces of subparts 12a and 12b, thereby providing high-resolution surfaces for subparts 12a and 12b. Subparts 12a and 12b may then be secured together by inserting link portion 16b into aperture 28a (represented by arrow 40). This procedure may then be repeated for each subpart 12 of 3D model 10 to assemble 3D model 10. The resulting 3D model 10 exhibits the high resolution exterior surfaces of each subpart 12, which, as discussed above, is attained with the additive deposition process. Furthermore, the bulk solid volume of 3D model 10 is formed from the base seeds derived from a subtractive removal process. This combination of the subtractive removal process, the additive deposition process, and the assembly process reduces the amount of materials required for the additive deposition process by limiting the additive deposition process merely forming surface features. Moreover, this combination precludes the need of support materials for supporting overhanging regions of 3D model 10, thereby reducing deposition times and material costs.

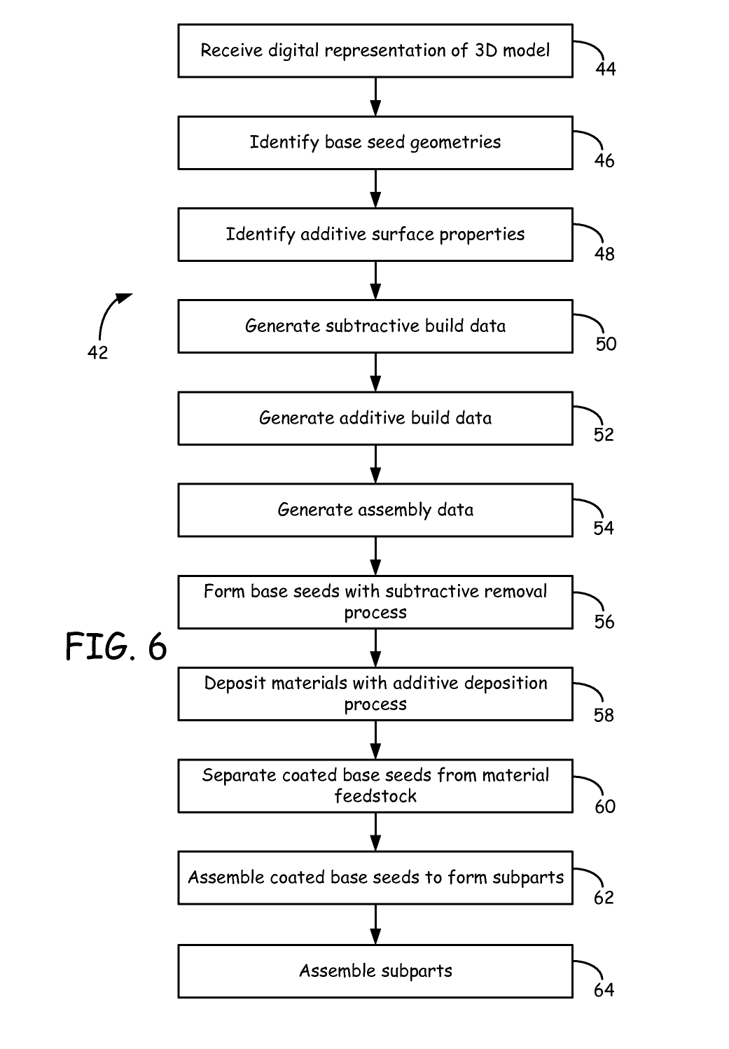

FIG. 6 is a flow diagram of method 42, which is an example of a suitable embodiment of the method of the present disclosure. As discussed below, method 42 desirably relies on a computer-based system to manipulate digital data. Accordingly, the digital data may be stored one or more computer storage media of the computer-based system (e.g., volatile and non-volatile media), where the computer-based system may be a single computer unit or multiple networked computer units. The following discussion of method 42 is made with reference to 3D model 10 with the understanding that method 42 may be used to build 3D models having a variety of different geometries and complexities.

Method 42 includes steps 44-64, and initially involves receiving a digital representation of 3D model 10 (step 44). For example, a customer may submit the digital representation to a manufacturer that operates one or more digital manufacturing systems. The manufacturer may receive the digital representation from a variety of media, such as over an Internet network or on a physical data storage medium. Upon receipt, the digital representation may be stored on one or more computer storage media of the computer-based system, and the computer-based system may initially clean up and reorient the digital representation to desirably optimize one or more production properties.

The computer-based system may then be used to identify suitable base seed geometries for building 3D model 10 (step 46). As discussed above, the base seeds (e.g., base seeds 18 and 20) desirably define the bulk solid volume of 3D model 10. Thus, the computer-based system desirably identifies building-block geometries that provide a close match to the overall geometry of 3D model 10. In the above-discussed example, 3D model 10 may be divided into a plurality of subparts 12. Each subpart 12 may then be divided into a plurality of base seeds 18 and 20 to allow target surfaces 24 and 26 to be coated with the additive deposition process. The computer-based system also desirably retains the dimensions, orientations, and coordinate locations of the identified base seed geometries on computer storage media.

In one embodiment, the base seed geometries may be identified from a library of base seed geometries retained on computer storage media of the computer-based system. In this embodiment, the digital representation of 3D model 10 may be divided into a plurality of geometries that match one or more base seed geometries from the stored library. In an alternative embodiment, the computer-based system may generate the identified base seed geometries based on a geometry algorithm that is suitable for fabricating the base seeds (e.g., base seeds 18 and 20) with a subtractive removal process.

In addition to identifying the base seed geometries, the computer-based system may also be used to identify the additive surface properties for forming one or more topographical features, coating, and/or color patterns, such as coatings 32 and 34 (step 48). Many 3D models may have topographical features that do not conform to the geometries of the identified base seeds, and/or may exhibit color patterns that cannot be attained with a subtractive removal process. As such, the computer-based system also desirably identifies the properties of the exterior surface of 3D model 10, such as the geometries of topographical features, color patterns, coating dimensions, and combinations thereof. This involves identifying properties of the target surface of each base seed that exhibits a surface corresponding to an exterior surface of the 3D model. For example, the computer-based system may identify the properties of any topographical features, color patterns, and/or other coatings that may be required for forming such features on target surfaces 24 and 26 of base seeds 18 and 20, such as coatings 32 and 34.

The computer-based system may then generate build data for performing the subtractive removal process (step 50). The subtractive build data may be generated based at least in part on the identified base seed geometries from step 46 of method 42, on the particular subtractive removal process being used, and on the material feedstock being used. For example, in a CNC process, the subtractive build data may include instructions for operating a CNC system, such as a timing sequence and removal patterns for selectively removing material to create base seeds 18 and 20 from one or more material feedstock 22.

The computer-based system may also generate build data for performing the additive deposition process (step 52). The additive build data may be generated based at least in part on the identified additive surface properties from step 48 of method 42, on the particular additive system being used, and on the material being used for the additive deposition process. For example, in a jetting process, the additive build data may include instructions required to operate a jetting deposition station, such as a timing sequence and deposition pattern for depositing one or more materials on target surfaces 24 and 26 in a layered-by-layer additive manner.

The computer-based system may also generate build data for performing the assembly process (step 54). The assembly build data may be generated based at least in part on the dimensions, orientations, and geometries of the base seeds, and on the particular assembly system used to assemble the base seeds. For example, in an automated assembly system, the assembly build data may include instructions required to operate robotic manipulators that manipulate and combine base seeds 18 and 20 to form each subpart 12, and for assembling the subparts 12 to build 3D model 10.

The resulting build data from steps 50, 52, and 54, along with any additional information for the production operation, may be relayed to a manufacturing system for building 3D model 10. The production operation desirably involves forming a plurality of base seeds 18 and 20 from one or more material feedstock (e.g., material feedstock 22) using the subtractive removal process, pursuant to the generated subtractive build data (step 56). One or more materials may then be deposited on one or more of target surfaces 24 and 26 using the additive deposition process to form high-resolution features, color patterns, and/or other coatings, pursuant to the generated additive build data (step 58).

As discussed above, at this point in the build operation, the coated base seeds 18 and 20 typically remain integrally attached to the remaining portion of material feedstock 22. As such, the coated base seeds 18 and 20 are desirably separated from the remaining portion of material feedstock 22 to allow the coated base seeds to be removed and manipulated (step 60). For example, the coated base seeds 18 and 20 may be separated from the material feedstock 22 with the use of a hot-wire foam knife. As further discussed above, the separation process of step 60 may be performed after the additive deposition process of step 58, which is beneficial for restricting movement of base seeds 18 and 20 during the additive deposition process. However, in an alternative embodiment, the separation process of step 60 may be performed prior to performing the additive deposition process of step 58.

The resulting coated base seeds 18 and 20 may then be assembled into subparts 12 (step 62), and subparts 12 may be assembled into the resulting 3D model 10 (step 64). As discussed above, the assembly process may be performed manually or in an automated manner. In an automated system, one or more robotic manipulators may manipulate and combine base seeds 18 and 20 to form each subpart 12, and assemble the subparts 12 to build 3D model 10, pursuant to the generated assembly data from step 54. Accordingly, the assembly process under steps 62 and 64 of method 42 may be performed in a serial or parallel manner to build 3D model 10. The resulting 3D model 10 may then undergo one or more post-production operations.

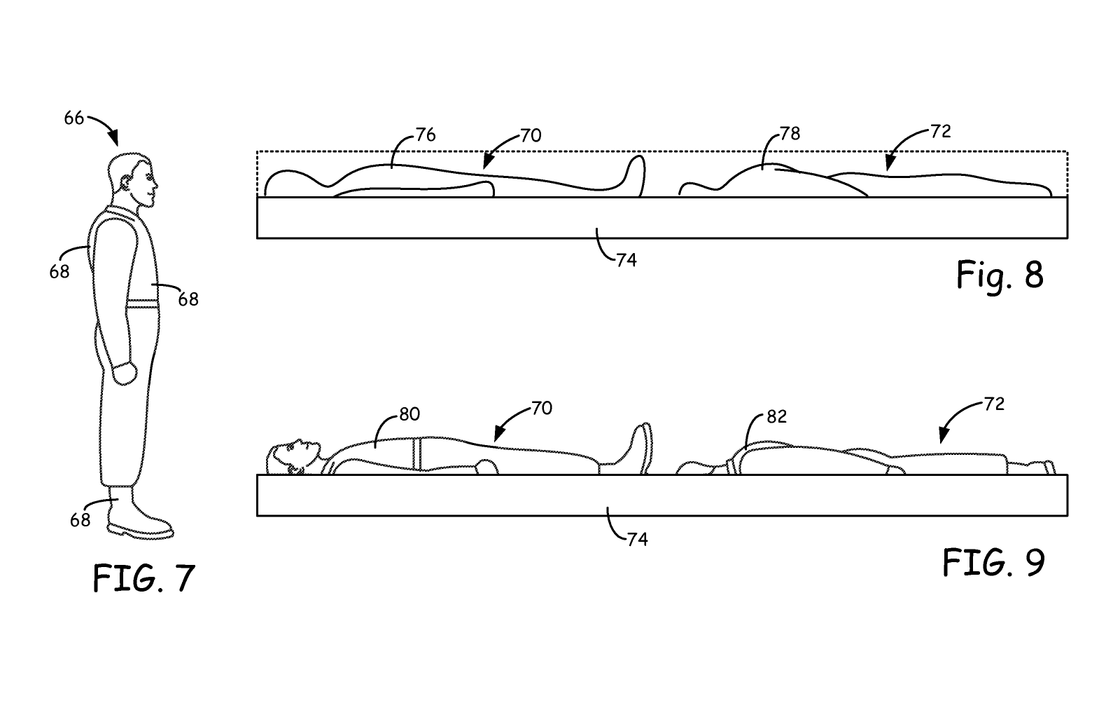

FIGS. 7-9 illustrate 3D model 66, which is an additional exemplary 3D model that may be built from a digital representation pursuant to method 42 (shown in FIG. 6). As shown in FIG. 7, 3D model 66 has an exterior surface 68 that extends around the entire body of 3D model 66, where exterior surface 68 includes a variety of topographical features and desirably includes one or more color patterns. As discussed above, 3D model 10 (shown in FIG. 1) exhibits extensive interstitial regions, which would require large amounts of support material when built solely with a deposition-based digital manufacturing system. In comparison, 3D model 66 does not contain any interstitial voids, and would not require large amounts of support material. However, the bulk volume of 3D model 66 itself would require a significant amount of time to build with a deposition-based digital manufacturing system, where the system would deposit roads of a modeling material in a layer-by-layer manner. Thus, 3D models 10 and 66 provide opposing examples of the benefits of the method of the present disclosure over individual CNC systems and digital manufacturing systems.

Accordingly, pursuant to steps 44-54 of method 42, a computer-based system may identify suitable base seed geometries and the surface properties for exterior surface 68, and generate the appropriate build data for building 3D model 10. A subtractive removal process may then be performed on one or more material feedstock, pursuant to step 56 of method 42, to form base seeds corresponding to the identified base seed geometries.

FIG. 8 shows base seeds 70 and 72 formed from material feedstock 74, where the original dimensions of material feedstock 74 are illustrated with broken lines. Because internal voids are not present, 3D model 66 may be assembled from only a pair of base seeds. This allows a higher volume ratio of 3D model 66 to be fabricated from material feedstock 74 (relative to material formed with the additive deposition process). This reduces the production time required to fabricate base seeds 70 and 72, and to assemble base seeds 70 and 72 to form 3D model 66. As shown, base seeds 70 and 72 respectively include target surfaces 76 and 78, which are formed from by selectively removal portions of material feedstock 74.

Pursuant to step 58 of method 42, one or more materials may be deposited on target surfaces 76 and 78 using the additive deposition process. As shown in FIG. 9, this forms coating surfaces 80 and 82, which desirably correspond to the high-resolution features and color patterns of exterior surface 68 of 3D model 66 (shown in FIG. 7). Base seeds 70 and 72 may then be separated from the remaining portion of material feedstock 74 (pursuant to step 60 of method 42), and assembled together to form 3D model 66 (pursuant to steps 60 and 62 of method 42). As discussed above, an adhesive coating may also be applied to the mating surfaces of base seeds 70 and 72 to adhere base seeds 70 and 72 together. The resulting 3D model 66 exhibits the high-resolution features and color patterns attained with the additive deposition process, while also reducing production times and material costs that are otherwise associated with digital manufacturing techniques.

In the above-discussed examples for 3D models 10 and 66, each base seed is paired with a reciprocating base seed. In the example for 3D model 10, pairs of base seeds 18 and 20 are secured together to form each subpart 12, and multiple subparts 12 are then assembled to form 3D model 10. Alternatively, in the example for 3D model 66, 3D model 66 may be assembled by merely securing base seeds 70 and 72 together. These embodiments illustrate two examples of many different base seed arrangements that may be used to build 3D models pursuant to method 42. For example, in embodiments in which the bulk volumes of a desired 3D model are larger than the material feedstock available, one or more blocks of unprocessed material feedstock may function as interior base seeds. In these embodiments, the given block(s) are not machined, coated, or separated pursuant to steps 56, 58, and 60 of method 42, may be directly manipulated pursuant to steps 62 and 64 of method 42. Accordingly, method 42 is suitable for building 3D models, from a plurality of base seeds, where each base seed includes at least one mating surface, and where at least one of the base seeds includes a target surface for receiving one or more deposited materials.

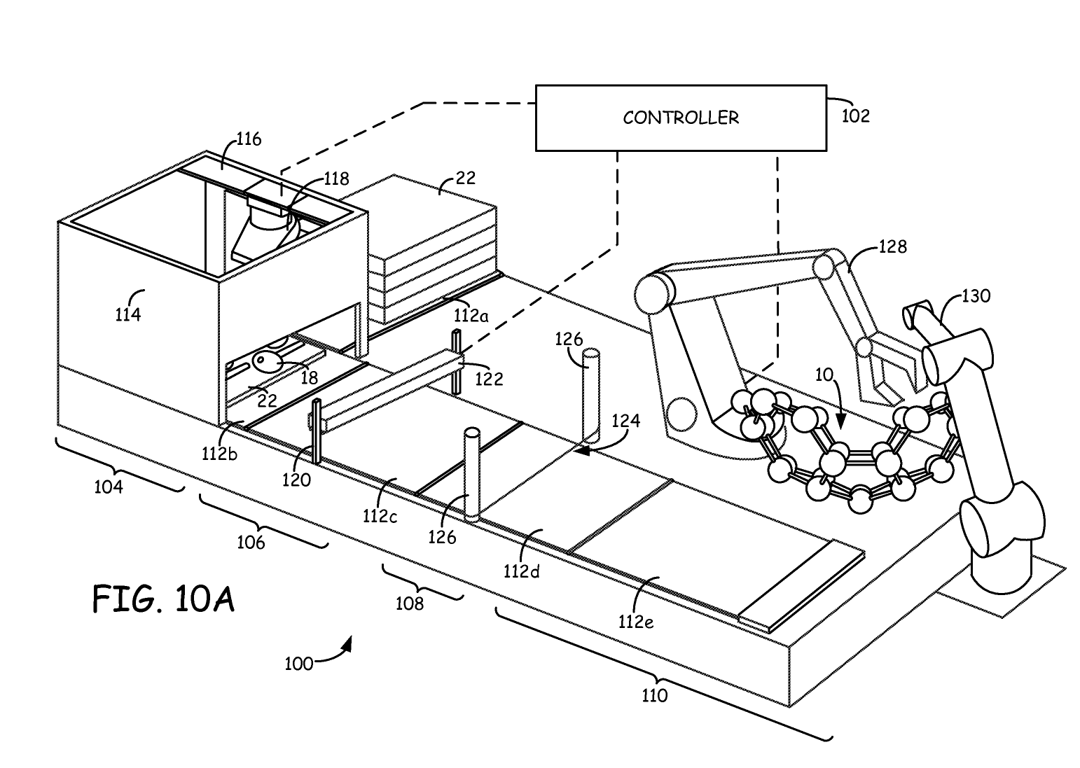

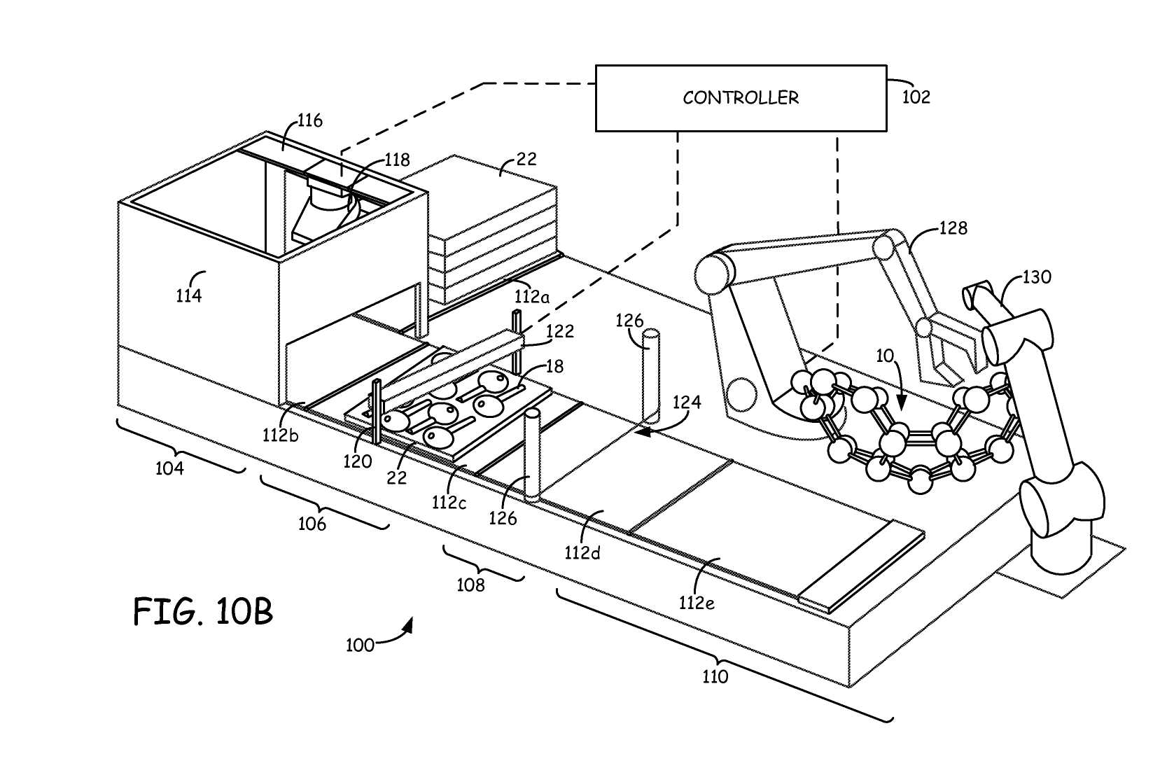

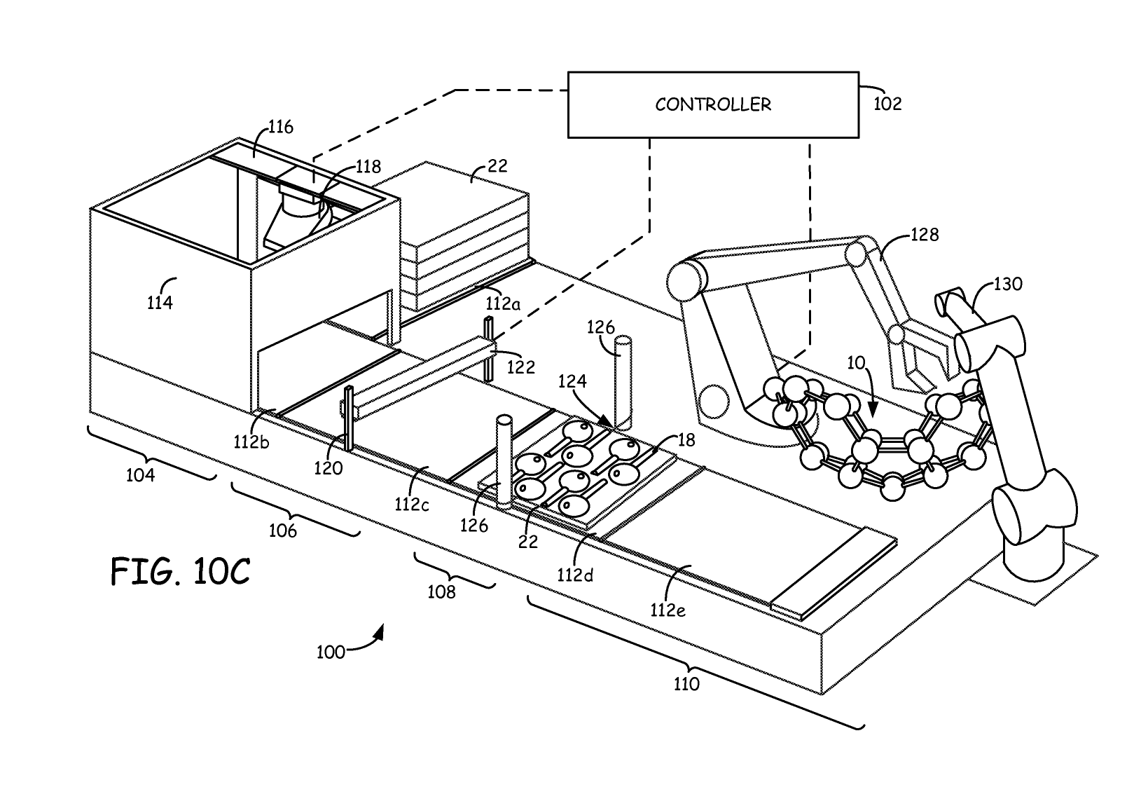

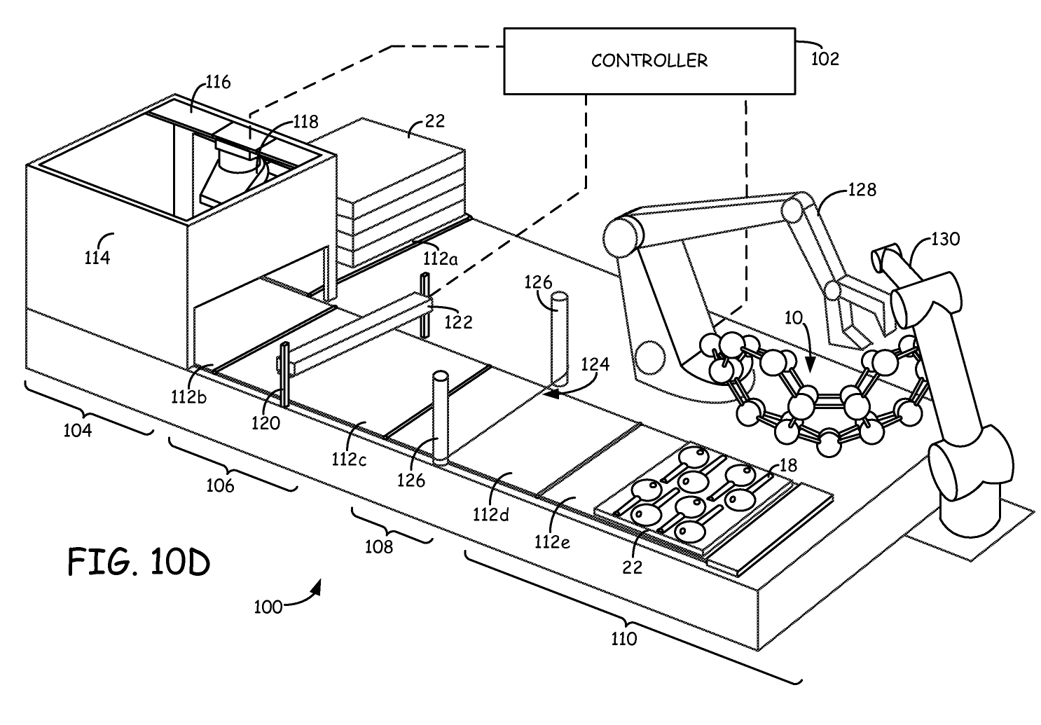

FIGS. 10A-10D illustrate system 100 in operation, where system 100 is a suitable automated system for building 3D models having a variety of complex geometries pursuant to steps 56-64 of method 42 (shown in FIG. 6). The following discussion of system 100 is made with reference to 3D model 10 (shown in FIGS. 1-5) with the understanding that system 100 is suitable for building 3D models having a variety of different geometries and complexities (e.g., 3D model 66, shown in FIGS. 7-9).

As shown in FIG. 10A, system 100 includes controller 102, CNC station 104, deposition station 106, separation station 108, and assembly station 110, which are successive stations for building 3D model 10 from multiple blocks of material feedstock 22. System 100 also includes conveyor belts 112a-112e, which are motion systems for moving successive blocks of material feedstock 22 to each of the successive stations. In one embodiment, conveyor belts 112a-112e are capable of being operated independently to allow the multiple stations of system 100 to be operated simultaneously. In alternative embodiments, a variety of different motion systems may be used to move blocks of material feedstock 22 to each of the successive stations.

Controller 102 is a computer-based controller and is desirably in signal communication with CNC station 104, deposition station 106, separation station 108, assembly station 110, and conveyor belts 112a-112e. Controller 102 is also desirably in signal communication with the computer-based system (not shown) for receiving the generated build data (pursuant to steps 40-50 of method 42). In various embodiments, controller 102 may be provided as a single control unit or as a network of multiple control units.

CNC station 104 is a CNC unit that includes chamber housing 114, gantry apparatus 116, and tool head 118, and is capable of performing a subtractive removal process on a received material feedstock 22, pursuant to step 56 of method 42. Correspondingly, deposition station 106 is a deposition-based digital manufacturing system that includes gantry apparatus 120 and deposition head 122, and is capable of performing an additive deposition process on the received base seeds, pursuant to step 58 of method 42. Deposition station 106 may also include an enclosable build chamber (not shown), which is particularly suitable for extrusion-based deposition processes (e.g., fused deposition modeling processes).

Separation station 108 is a unit configured to separate the base seeds from the remaining portion of material feedstock 22, pursuant to step 60 of method 42. In the embodiment shown, separation station 108 includes wire 124 retained above conveyor belt 74d by support towers 126, where wire 124 is desirably a hot-wire foam knife. The use of a hot-wire foam knife for separation station 108 is particularly suitable for use with material feedstock 22 derived from one or more foamed polymers.

Assembly station 110 is the portion of system 100 configured to manipulate the separated base seeds to build 3D model 10 (shown in partial completion), pursuant to steps 62 and 64 of method 42. In the shown embodiment, assembly station 110 includes robotic manipulators 128 and 130, which are desirably multiple-axis (e.g., 5-axis) robotic appendages capable of manipulating the separated base seeds to assemble 3D model 10. While shown with a pair of robotic manipulators, assembly station 110 may include any suitable number of robotic manipulators to assemble 3D models. Furthermore, assembly station 110 may include one or more additional robotic manipulators (not shown) to spray or otherwise coat the mating surfaces of the base seeds with adhesive materials prior to joining the pairs of the base seeds.

While shown with a single CNC station 104, a single deposition station 106, a single separation station 108, and a single assembly station 110, system 100 may alternatively include multiple CNC stations 104, multiple deposition stations 106, multiple separation stations 108, and/or multiple assembly stations 110. Each of the multiple stations is desirably in signal communication with controller 102 for the transmission of operating instructions and feedback.

During production of 3D model 10, controller 102 directs conveyor belts 112a and 112b to supply one or more of material feedstock 22 to CNC station 104. Conveyor belts 112a and 112b desirably direct material feedstock 22 to a preset x-y coordinate location within chamber housing 114 to allow the selective removal to be performed accurately. Additionally or alternatively, CNC station 104 may include one or more sensors (e.g., optical and contact sensors, not shown) for calibrating tool head 118 relative to the received material feedstock 22.

Upon receipt of material feedstock 22, controller 102 relays commands to CNC station 104 to direct gantry apparatus 116 to move tool head 118 around within chamber housing 114, and to direct tool head 116 to selectively remove portions of material feedstock 22 to attain one or more base seeds (e.g., base seeds 18 and 20). For example, controller 102 may relay G-code and M-code commands to CNC station 104 to direct the subtractive removal process. In alternative embodiments, gantry apparatus 116 may be replaced with a variety of different gantry assemblies that provide relative movement between the received material feedstock 22 and tool head 114. For example, conveyor belt 122b may also be retained by a gantry assembly for moving material feedstock 22 relative to tool head 114.

After the subtractive removal process is complete, the excess removed material may be removed (e.g., blown or vacuum off), and controller 102 may direct conveyor belts 112b and 112c to supply the resulting block with the formed base seeds to deposition station 106. As shown in FIG. 10B, conveyor belts 112b and 112c desirably direct the formed base seeds to a preset x-y coordinate location within deposition station 106 to allow the deposition process to be performed accurately. Additionally or alternatively, deposition station 106 may include one or more sensors (e.g., optical and contact sensors, not shown) for calibrating deposition head 122 relative to the received base seeds.

Upon receipt of material feedstock 22, controller 102 relays commands to deposition station 106 to direct gantry apparatus 120 to move deposition head 122 around within the x-y-z coordinate system, and to direct deposition head 122 to selectively deposit one or more materials on the target surfaces of the base seeds (e.g., target surfaces 24 and 26) to form topographical feature(s), color pattern(s), and/or other coating(s) on the target surfaces (e.g., coatings 32 and 34). In the embodiment shown, deposition head 122 is a jetting head that includes an array of selectively-activatable orifices for depositing jetting materials. Examples of suitable jetting heads for deposition head 122 include continuous and drop-on-demand jetting heads, and systems disclosed in Zinniel et al., U.S. Pat. No. 7,236,166. Examples of suitable commercially available jetting heads for deposition head 122 include those under the trade designation “SPECTRA SX-128” from Dimatix Fujifilm, Inc., Santa Clara, Calif. Suitable deposition rates range from about 2 millimeter/hour to about 4 millimeters/hour.

In some embodiments, deposition station 106 may also include one or more planarizers, such as those disclosed in Zinniel et al., U.S. Pat. No. 7,236,166. The planarizer(s) are beneficial for reducing the effects of deposition volume variability when large numbers of layers are formed. Furthermore, in embodiments in which the jetted material is photocurable, deposition station 106 may also include one or more curing units (e.g., ultraviolet sources) to readily crosslink the jetted layers.

In alternative embodiments, deposition head 122 may be an extrusion head, such as those disclosed in Leavitt et al., U.S. patent application Ser. No. 11/888,076, entitled “Extrusion Head For Use In Extrusion-Based Layered Deposition Modeling”; and in LaBossiere et al., U.S. Publication No. 2007/0228590. In these embodiments, deposition station 106 desirably includes a build chamber (not shown) configured to be maintained at an elevated temperature to reduce the risk of part distortion, as disclosed in Swanson et al., U.S. Pat. No. 6,722,872.

In additional alternative embodiments, gantry apparatus 120 may be replaced with a variety of different gantry assemblies that provide relative movement between the target surfaces of the base seeds and deposition head 122. For example, deposition head 122 may be supported by a multiple-axis (e.g., 5-axis) robotic appendage, which is suitable for ejecting materials onto lateral target surfaces of the base seeds. Additionally, conveyor belt 112c may be configured to move along one or more axes in the x-y-z coordinate system to move the base seeds relative to deposition head 122. In additional alternative embodiments, deposition system 122 may include multiple deposition heads supported by one or more gantry assemblies, thereby allowing multiple deposition processes to be performed simultaneously and/or to allow multiple materials to be deposited.

After the additive deposition process is complete, controller 102 may then direct conveyor belts 112c and 112d to supply the resulting block with the coated base seeds to separation station 108. As shown in FIG. 10C, wire 124 may be heated by electrical resistance to an elevated temperature that is suitable for melting and/or vaporizing the contacted material of material feedstock 22. As the material feedstock 22 travels along conveyor belt 112d, contact between wire 124 and the material of material feedstock 22 separates the base seeds from the remaining portion of material feedstock 22. In embodiments in which material feedstock 22 is derived from foamed polymers (e.g., foamed polystyrene), the elevated temperature of wire 124 may vaporize the polymer prior to contact, thereby reducing the risk of moving the base seeds in the horizontal x-y plane.

Controller 102 may also direct conveyor belts 112d and 112e to supply the resulting block with the separated coated base seeds to assembly station 110, as shown in FIG. 10D. Conveyor belts 112d and 112e desirably direct the separated coated base seeds to a preset x-y coordinate location within assembly station 110 to allow the assembly process to be performed accurately. Additionally or alternatively, deposition station 110 may also include one or more sensors (e.g., optical and contact sensors, not shown) for calibrating robotic manipulators 128 and 130 relative to the received base seeds. Controller 102 may then direct robotic manipulators 128 and 130 to assemble two or more of the base seeds to form subparts (e.g., subpart 12), and combine the subparts to build 3D model 10.

When the assembly process is complete, the resulting 3D model 10 may be removed from system 100 and one or more post-processing steps (e.g., vapor smoothing processes) may be performed to finish the production. The resulting 3D model 10 exhibits good structural integrity, and may include exterior surfaces having high-resolution topographical features, color patterns, and/or other coatings defined by the additive deposition process. The combination of the subtractive removal process, the additive deposition process, and the assembly process in the automated system 100 also allows 3D models to be built with reduced production times and reduced material costs. For example, if 3D model 10 exhibits a geometry having a 9-inch bounding box, the solids volume of 3D model 10 is about 60 cubic inches (i.e., about 8% by volume of the bounding box). Suitable production times for fabricating each base seed include about 5 minutes for the subtractive removal process, about 10 seconds for the additive deposition process, and about 30 seconds for the assembly process. In a situation in which each base seed is completed before a subsequent base seed is fabricated (i.e., a worst-case scenario), the total production time for building 3D model 10 is about 11 hours. Furthermore, if 3D model 66 exhibits similar dimensions, the above-discussed process may build 3D model 66 in a fraction of that production time the large volume that may be used for each mating seed.

Although the present disclosure has been described with reference to preferred embodiments, workers skilled in the art will recognize that changes may be made in form and detail without departing from the spirit and scope of the disclosure.

1. A method for building a three-dimensional model, the method comprising:
performing a subtractive removal process on at least one material feedstock to form a plurality of base seeds, wherein each of the plurality of base seeds comprises a mating surface, and at least one of the base seeds comprises a target surface;
performing an additive deposition process to deposit at least one material on at least a portion of the target surface to provide a coated target surface; and
performing an assembly process to combine the plurality of base seeds to form at least a portion of the three-dimensional model, wherein the coated target surface constitutes at least a portion of an exterior surface of the three-dimensional model.

2. The method of claim 1, wherein performing the subtractive removal process comprises selectively removing one or more portions of the at least one material feedstock.

3. The method of claim 1, wherein the additive deposition process comprises a process selected from the group consisting of a jetting process, a fused deposition modeling process, and a combination thereof.

4. The method of claim 1, wherein performing the assembly process comprises securing the mating surface of a first of the plurality of base seeds to the mating surface of a second of the plurality of base seeds.

5. The method of claim 1, and further comprising separating the plurality of base seeds from the at least one material feedstock.

6. The method of claim 1, wherein the at least one material feedstock compositionally comprises a foamed polymeric material.

7. The method of claim 1, and further comprising:
identifying base seed geometries for each of the plurality of base seeds; and
generating first data instructions based at least in part on the identified base seed geometries, wherein the first data instructions are configured to direct a production system to perform the subtractive removal process.

8. The method of claim 7, and further comprising:
identifying additive surface properties for depositing the at least one material; and
generating second data instructions based at least in part on the identified additive surface properties, wherein the second data instructions are configured to direct the production system to perform the additive deposition process.

9. A method for building a three-dimensional model, the method comprising:
selectively removing at least a portion of at least one material feedstock to form a plurality of base seeds, wherein at least a portion of the plurality of base seeds each comprise a target surface;
depositing a material onto the target surfaces to form at least one surface feature selected from the group consisting of topographical features, color patterns, coatings, and combinations thereof;
separating the plurality of base seeds from the at least one material feedstock; and
assembling the plurality of base seeds to form at least a portion of the three-dimensional model, wherein the at least one surface feature constitutes at least a portion of an exterior surface of the three-dimensional model.

10. The method of claim 9, wherein selectively removing the portion of the at least one material feedstock comprises causing relative movement between a removal tool and the at least one material feedstock.

11. The method of claim 9, wherein depositing the material onto the target surfaces comprises a process selected from the group consisting of jetting the material onto the target surfaces in a layer-based additive manner, extruding the material onto the target surfaces in a layer-based additive manner, and a combination thereof.

12. The method of claim 9, wherein assembling the plurality of base seeds comprises securing a mating surface of a first base seed of the plurality of base seeds to a mating surface of a second base seed of the plurality of base seeds.

13. The method of claim 9, and further comprising:
identifying base seed geometries for each of the plurality of base seeds; and
generating first data instructions based at least in part on the identified base seed geometries, wherein the first data instructions are configured to direct a production system to selectively remove the portion of the at least one material feedstock.

14. The method of claim 13, and further comprising:
identifying additive surface properties for depositing the at least one material; and
generating second data instructions based at least in part on the identified additive surface properties, wherein the second data instructions are configured to direct the production system to deposit the material onto the target surfaces.

15. A system for building a three-dimensional model, the system comprising:
at least one subtractive removal station configured to form a plurality of base seeds from at least one material feedstock, wherein each of the plurality of base seeds comprises a mating surface, and at least one of the seeds comprises a target surface;
at least one additive deposition station configured to deposit at least one material on at least a portion of the target surface to provide a coated target surface; and
at least one assembly station comprising at least one robotic manipulator configured to combine the plurality of base seeds to form at least a portion of the three-dimensional model, wherein the coated target surface constitutes at least a portion of an exterior surface of the three-dimensional model.

16. The system of claim 15, and further comprising at least one motion assembly configured to move the at least one feed stock material between at least the at least one subtractive removal station and the at least one additive deposition processing station.

17. The system of claim 15, and further comprising a controller configured to receive digital data relating to the three-dimensional model, wherein the controller is in signal communication with the at least one subtractive removal station, the at least one additive deposition station, and the at least one assembly station.

18. The system of claim 15, and further comprising at least one separation station configured to separate the plurality of base seeds from the at least one material feedstock.

19. The system of claim 15, wherein the at least one subtractive removal station comprises a computer numerical control system.

20. The system of claim 15, wherein the at least one additive deposition station comprises a deposition head selected from the group consisting of a jetting head, an extrusion head, and combinations thereof.
